(19) United States
(12) Patent Application Publication
(10) Pub. No.: US 2009/0249412 A1
(43) Pub. Date: Oct. 1, 2009

(54) MANAGING ACQUISITION OF FEE BASED VIDEOS

(75) Inventors: Kulvir S. Bhogal, Fort Worth, TX (US); Gregory J. Boss, American Fork, UT (US); Rick A. Hamilton, II, Charlottesville, VA (US); Brian M. O'Connell, Cary, NC (US)

Correspondence Address: IBM Endicott- DeLizio Gilliam, PLLC, c/o DeLizio Gilliam, PLLC, 15201 Mason Road Suite 1000-312, Cypress, TX, 77433, US

(73) Assignee: International Business Machines Corporation, Armonk, NY (US)

(21) Appl. No.: 12/054,951

(22) Filed: Mar. 25, 2008

(51) Int. Cl. H04N 7/173

(52) U.S. Cl. 725/104

(57) ABSTRACT

Purchasing PPV movies and events can be quite expensive for a viewer particularly when multiple PPV videos are purchased. Functionality can be implemented in a video recording device to search for less expensive alternatives for acquiring selected PPV content and other fee based videos. Automatically searching for lower fees and other lower-cost sources of a PPV video removes the tedium of manually checking for fee decreases for the selected PPV video and allows for more cost effective video recording.

### BACKGROUND

Embodiments of the inventive subject matter generally relate to the field of video recording and, more particularly, to management of fee based video recording.

A digital video recorder (DVR) (a.k.a. personal video recorder or PVR) is a device that records audio and video content in a digital format to a disk drive or other medium. DVRs include stand-alone set-top boxes and software for personal computers, where the software enables content capture and playback to and from disk. DVRs provide convenient “time shifting” and other features, such as pausing live TV, instant replay of scenes, chasing playback, skipping advertising, etc. Most DVRs use a Motion Pictures Expert Group format for encoding video signals.

Many television content distributors, such as Time Warner Cable and Dish Network, offer subscribers the ability to purchase and watch movies and other events, such as concerts, for a one-time usage fee (e.g., pay per view (PPV) etc.). In some cases, movies that have just been released to PPV are more expensive than movies that have been available on PPV for a few weeks. A viewer, being aware of PPV pricing strategies, may want to view a PPV movie at some time in the future for a decreased fee.

### SUMMARY

Embodiments include a method directed to detecting selection of a fee based video which is accessible for a current fee from a content provider. A time is identified when the video will be accessible for a future fee. The future fee is less than or equal to an indicated fee and the time is within a given time threshold. Acquisition of the video is scheduled at the time.

### BRIEF DESCRIPTION OF THE SEVERAL DRAWINGS

The present embodiments may be better understood, and numerous objects, features, and advantages made apparent to those skilled in the art by referencing the accompanying drawings.

FIG. 1 illustrates an example content delivery system.

FIG. 2 depicts a flowchart of example operations to acquire a fee based video below an indicated fee and within a time threshold.

FIGS. 3-4 depict flowcharts of example operations for acquiring fee based videos within time and price constraints. FIG. 3 depicts a flowchart of operations for acquiring fee based videos within time and price constraints.

FIG. 4 depicts a flowchart of operation that continues from the flowchart depicted by FIG. 3.

FIG. 5 depicts an example computer system.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to digital video recorders and personal video recorders, embodiments can be implemented with a video game console, a portable video recording device, a media center, a computer, etc. In other instances, well-known instruction instances, protocols, structures and techniques have not been shown in detail in order not to obfuscate the description.

Purchasing PPV movies and events can be quite expensive for a viewer particularly when multiple PPV videos are purchased. Functionality can be implemented in a video recording device to search for less expensive alternatives for acquiring selected PPV content and other fee based videos. Automatically searching for lower fees and other lower-cost sources of a PPV video removes the tedium of manually checking for fee decreases for the selected PPV video and allows for more cost effective video recording.

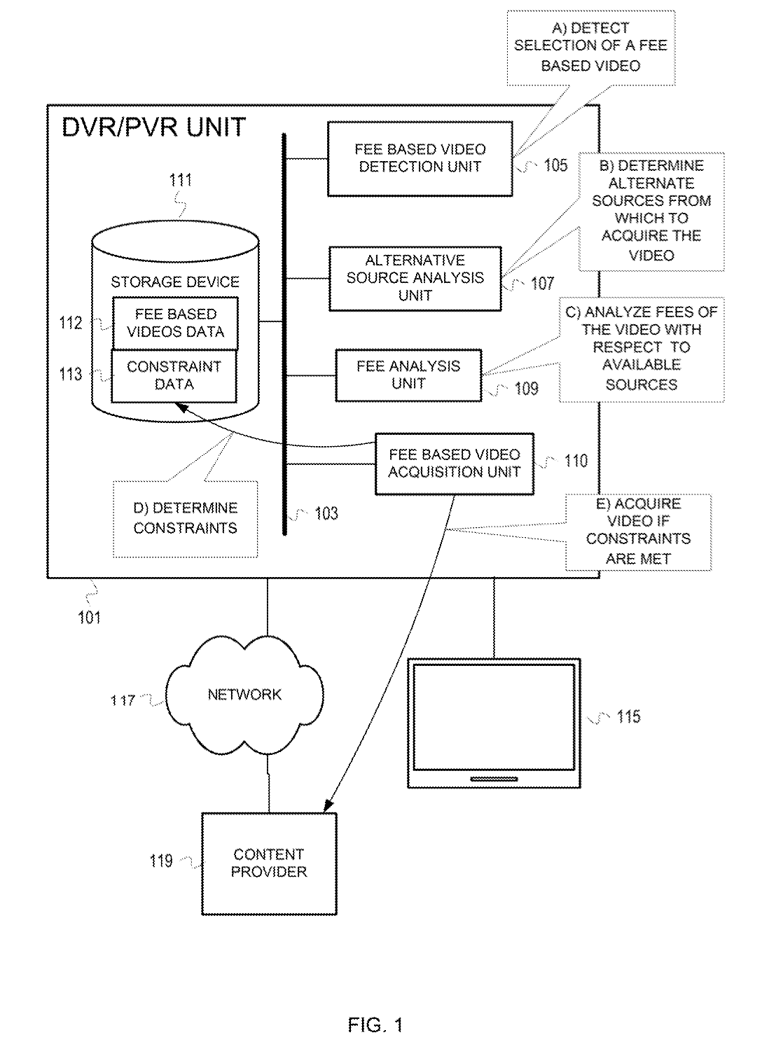

FIG. 1 illustrates an example content delivery system. The content delivery system includes a digital video recorder/personal video recorder (DVR/PVR) unit 101, display device 115 (e.g., television, monitor, projector, etc.), network 117, content provider 119. The content provider 119 can provide television content via a cable television infrastructure (e.g., optical fiber, coaxial cables, etc.) or other infrastructures, such as digital subscriber lines (DSL). The DVR unit 101 includes a fee based video detection unit 105, alternative source analysis unit 107, fee analysis unit 109, fee based video acquisition unit 110, and storage device 111, all of which are connected via a bus 103. Although FIG. 1 shows the DVR's components connected via a bus 103, the components can be connected using other technologies (e.g., software interfaces). The storage device 111 hosts fee based videos 112 and constraint data 113.

The fee based video detection unit 105 detects selection of a fee based video. A fee based video is video content made accessible to a user once a usage fee has been paid to the content provider (e.g. pay per view, video on demand (VOD), etc.). Examples of detecting selection of a fee based video include selecting a video for live viewing on a PPV channel, scheduling a recording from a PPV channel, requesting a video from a VOD service, etc. The alternate source analysis unit 107 searches alternate sources (e.g., searches an electronic programming guide, the Internet, online library of licensed video clubs, etc.) to determine if the selected video can be acquired from another source (e.g. different television channels, Internet, etc.). As an example, a fee based video may have been selected from a pay per view (PPV) channel, but identical content is also available on a premium movie channel, video on demand (VOD) and/or another PPV channel, etc.

The fee analysis unit 109 analyzes the fees of available sources of the video. To analyze fees, the fee analysis unit 109 accesses published past, current and future fees of one or more same or similar videos. Past and current fees of the selected video and/or similar videos may be analyzed to predict future fees, for example if future fees are not published. Examples of similar videos are videos played on the same channel, videos in the same genre, videos released in the same time period, videos by the same director, etc.

The fee based video acquisition unit 110 acquires fee based videos if the constraint data 113 are met. The constraint data 113 comprises an indicated fee and time threshold that are entered by a user (e.g., in response to a prompt, in a configuration menu, etc.). Default values can be assigned for the constraint data 113. The selected fee based video is acquired if a current fee is below (or equal to) the indicated fee, or a future fee (e.g., published fee, predicted fee, etc.) and within the time threshold. The fee based video data 112 consists of recorded or downloaded fee based videos.

In an embodiment, a search is performed for alternate sources of the selected video even if the constraint data is satisfied by the original content provider. If an alternate source is found that has the video available sooner or for a lower fee, the video may be obtained from the alternate source. A user can set configurations for acquiring the video. For example, the video can be automatically acquired from an alternate source, or an option to acquire the video from the alternate source can be displayed. In another embodiment, the selected fee based video may be acquired from the original content provider if the constraint data is satisfied. If the constraint data is not satisfied, a search is performed for alternate sources of the video. In another embodiment, the selection of a video is detected and all sources of the video are searched to find the lowest fee or soonest available showing.

Although not shown in FIG. 1, the DVR unit 101 includes components for recording and presenting content (e.g., video decoding logic, read/write logic, video turner(s), etc.). Furthermore, any of the components shown herein can include hardware, firmware, and/or machine-readable media including instructions for performing the operations described herein.

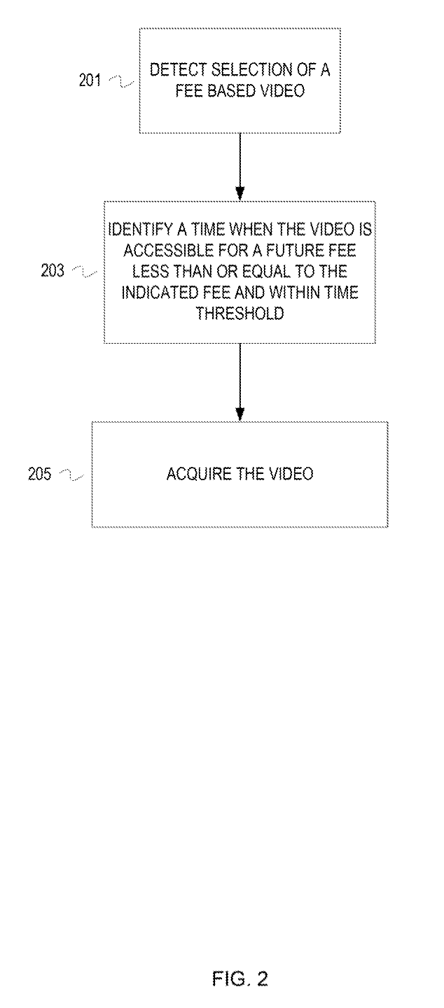

FIG. 2 depicts a flowchart of example operations to acquire a fee based video below an indicated fee and within a time threshold. Flow 200 begins at block 201, where selection of a fee based video is detected.

At block 203 a time is identified when the selected fee based video is accessible for a future fee less than or equal to an indicated fee and within a time threshold. Future fees could be a current fee, a published future fee, a predicted fee, etc. In one example, the indicated fee and time threshold that are entered by a user in response to a prompt. A video recording device can associate different weights to the different constraint data based on user or default configurations. A user can specify a preference for the time threshold over the indicated fee. As an example, a user may want to get the selected video at the lowest price possible without regard to when the video is acquired. As another example, the user may want to show the selected video to a group of friends on specific date, but wants get the selected video at the lowest price available before that date. Furthermore, the constraint data can indicate multiple acceptable ranges of fees and multiple thresholds with each having different weights.

At block 205, the selected video is acquired. The video could be acquired by either scheduling a recording or requesting a download.

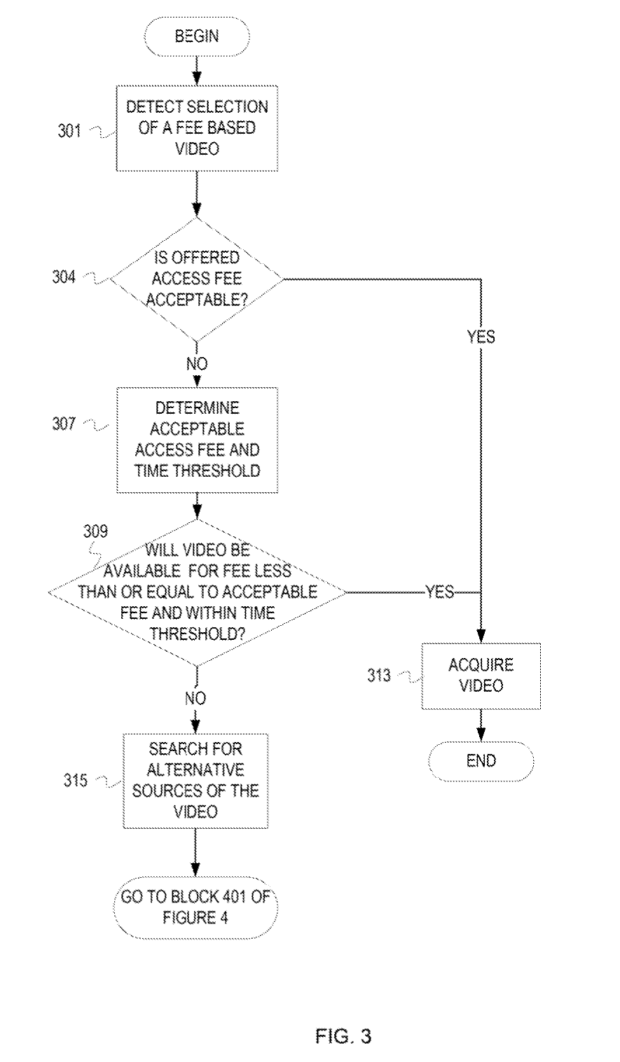

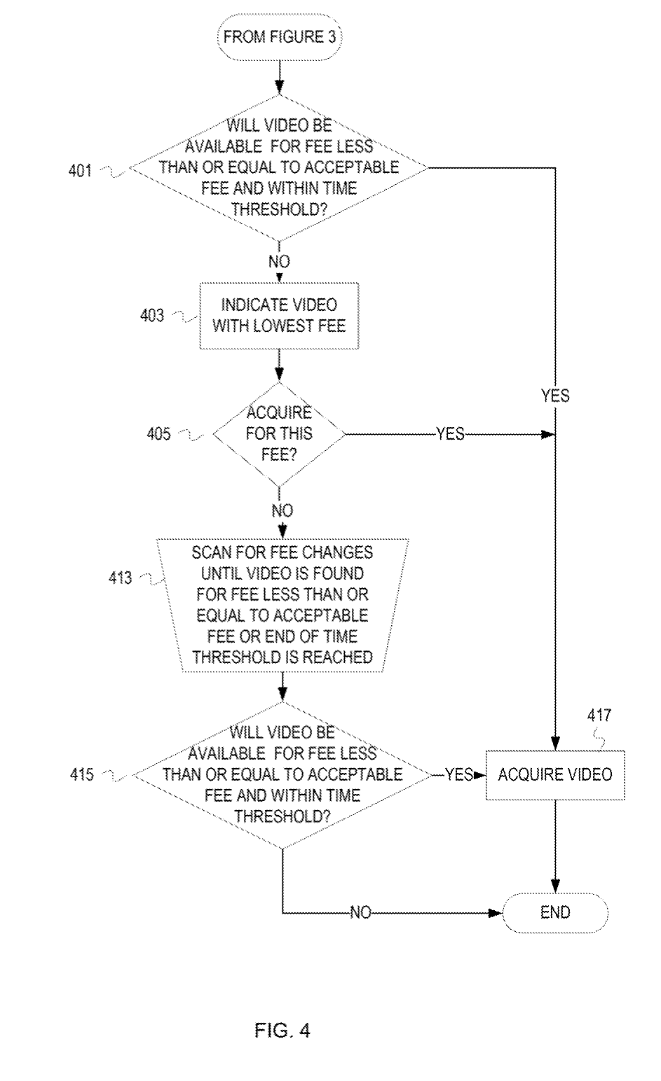

FIGS. 3-4 depict flowcharts of example operations for acquiring fee based videos within time and fee constraints. FIG. 3 depicts a flowchart of operations for acquiring fee based videos within time and price constraints. Flow begins at block 301, where selection of a fee based video is detected.

At block 304, it is determined if the offered access fee is acceptable. In one example, the offered access fee is compared against a stored acceptable fee previously defined by a user. In another example, the offered access fee is displayed and the user responds via a prompt to accept or reject the offered fee. If the offered access fee is acceptable, flow continues at block 313. If the offered fee is not acceptable, flow continues at block 307.

At block 307, the acceptable access fee and time threshold is determined. For instance, data indicating the threshold (e.g., previously set configuration) are retrieved from memory and/or storage. In one example, the acceptable access fee is determined with operations represented by block 304. In another example, the acceptable access fee and time threshold are entered by a user in response to a prompt. As an example, the acceptable access fee may be the absolute maximum fee the user is willing to pay for the selected fee based video. As another example, the acceptable access fee may be target fee with some flexibility.

At block 309, it is determined if the selected fee based video will be available for a fee less than or equal to the indicated fee and within the time threshold. Example techniques for determining future fees include examining future fees published in an EPG, predicting future fees based on historical fees of the selected video and similar videos, etc. Examples of similar videos are videos played on the same channel, videos in the same genre, videos released in the same time period, etc. If the selected video will be available for a fee less than or equal to the indicated fee and within the time threshold, flow continues at block 313. If the selected video will not be available for a fee less than or equal to the indicated fee and within the time threshold, flow continues at block 315.

At block 313, the selected fee based video is acquired by either scheduling a recording or requesting a download. After the video is acquired, the flow ends.

At block 315, a search for alternate sources of the selected fee based video is performed. The search can target content providers indicated in the EPG and/or on the Internet. Examples of alternate sources include other PPV channels, regular broadcast channels, premium channels, video on demand services, licensed online social network libraries, etc. The DVR considers identical content when searching for alternate sources. For example, if the selected fee based video was Spiderman 3, the search results would not contain Spiderman 2. Embodiments may also consider similar content when searching for alternative sources. For example, a search for a particular fighting even can return one or more fees for that particular fighting event and fees for other similar fighting events, thus allowing comparison. Flow continues to block 401 of FIG. 4.

FIG. 4 depicts a flowchart of operation that continues from the flowchart depicted by FIG. 3. At block 401, it is determined if the selected fee based video will be available from an alternate source for a fee less than or equal to the indicated fee and within the time threshold. Example techniques for determining future fees include examining future fees published in an EPG, predicting future fees based on historical fees of the selected video and similar videos, etc. Examples of similar videos are videos played on the same channel, videos in the same genre, videos released in the same time period, etc. If the selected video will be available for a fee less than or equal to the indicated fee and within the time threshold, flow continues at block 417. If the selected video will not be available for a fee less than or equal to the indicated fee and within the time threshold, flow continues at block 403.

At block 403, a video with the lowest access fee within the time threshold is indicated. For example, the recording device stores information about the video with the lowest access fee, thus allowing perusal by a user at a later time, on a different device (e.g., an e-mail with a link to acquire the video is sent to a portable communication device), etc. In another example, an indication of the video with the lowest access fee (e.g., video title and access fee) is displayed. The lowest access fee is a best match (i.e., lowest available price) to the acceptable fee since it was already determined that the video is not available from any content provider for a fee less than the indicated acceptable fee. In this embodiment, the DVR displays one option for acquiring the selected fee based video. In other embodiments, the DVR could display a number of different options for acquiring the fee based video. Flow continues at block 405.

At block 405, it is determined if the indicated fee based video should be acquired for the best match fee. A user responds (e.g., via a prompt, via proxy, via default settings, etc.) to accept or reject the best match fee. If the indicated fee based video should be acquired for the best match fee, flow continues at block 417. If the selected fee based video should not be acquired for the best match fee, flow continues at block 413.

At block 413, a loop is entered to scan for fee changes on any of the available sources to acquire the selected fee based video. The loop ends when either a fee for the selected fee based video is found below the acceptable fee and within the time threshold, or the end of the time threshold has been reached. The scan examines the EPG for fee changes at regular time intervals that correspond to the EPG update interval (e.g., daily). The scan examines fee information for any previously determined sources for the video and searches for any additional sources that may become available during the time threshold. Fees may change due to unplanned or unannounced fee decreases especially when future fee data is not made available by the content provider.

At block 415, it is determined if the selected fee based video will be available for a fee less than or equal to the indicated fee and within the time threshold. If the selected video will be available for a fee less than or equal to the indicated fee and within the time threshold, flow continues at block 417. If the selected video will not be available for a fee less than or equal to the indicated fee and within the time threshold, the flow ends.

At block 417, the indicated fee based video is automatically acquired. If the indicated fee based video can be acquired from more than one source for a fee less than or equal to the acceptable fee, the video with the lowest fee will be acquired. A user can set configurations for acquiring a video. As an example, configurations can indicate whether the user prefers to automatically acquire the fee based video or be presented with a list of acquisition options that fall within the fee and time constraints. The list of options may be useful to the user for comparing competing providers. For example, the selected video could be a movie shown on both a PPV channel and a premium movie channel. If the user is not already subscribed to the premium movie channel, the cost to acquire the movie is a one month subscription fee to the premium movie channel. The PPV option may cost less than a one month subscription to the premium movie channel, but the user would have access to additional movies on the premium movie channel if this option were selected. As another example, the selected video may be available for a fee on a PPV channel and for free on a regular broadcast channel with commercials. The user could weigh the value of getting a commercial free version from the PPV channel over the version with commercials.

It should be understood that the depicted flowchart are examples meant to aid in understanding embodiments and should not be used to limit embodiments or limit scope of the claims. Embodiments may perform additional operations, fewer operations, operations in a different order, operations in parallel, and some operations differently. For instance, referring to FIG. 3 the search for alternative sources of the video may occur before identifying if the selected fee based video will be available within fee and time constraints from the original content provider. For example, all available sources to acquire the selected fee based video are determined (including the original source) before the analysis of the fees for each source of the video.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

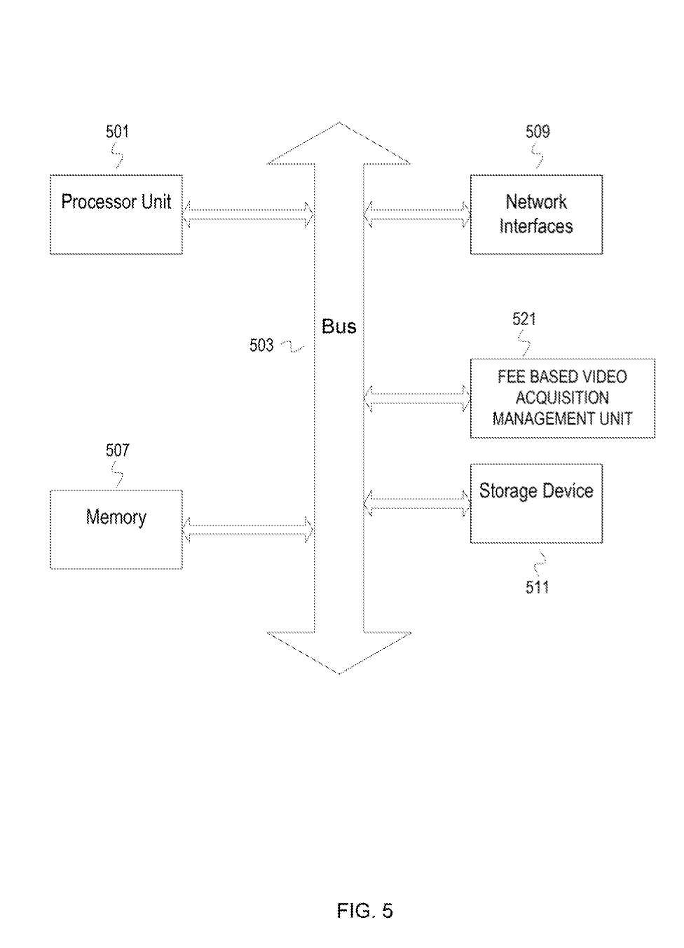

FIG. 5 depicts an example computer system. A computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport®, InfiniBand®, NuBus, etc.), a network interface 509 (e.g., an ATM interface, an Ethernet interface, a Frame Relay interface, SONET interface, wireless interface, etc.), and a storage device(s) 511 (e.g., optical storage, magnetic storage, etc.). The computer system includes a fee based video acquisition management unit 521. The fee based video acquisition unit 521 analyzes fees of one or more sources of a selected fee based video to determine if the selected video can be acquired for a fee less than or equal to an acceptable fee within a time threshold, and acquires the video if the fee and time constraints are met. Any one of these functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501, the storage device(s) 511, and the network interface 509 are coupled to the bus 503. Although illustrated as being coupled to the bus 503, the memory 507 may be coupled to the processor unit 501.

While the embodiments are described with reference to various implementations and exploitations, it will be understood that these embodiments are illustrative and that the scope of the inventive subject matter is not limited to them. In general, techniques as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
detecting an indication of a video which is accessible for a current fee from a content provider;
identifying a time when the video will be accessible for a future fee that is less than or equal to an indicated fee, wherein the time is within a given time threshold; and
scheduling acquisition of the video at the time.

2. The method of claim 1, wherein said identifying comprises at least one of analyzing historical video fee information for videos from the content provider, examining published future fees for the video from the content provider, and examining video fee information from other content providers.

3. The method of claim 2 further comprising predicting the future fee based, at least in part, on the analyzing historical video fee information.

4. The method of claim 1 further comprising prompting a user for the indicated fee and the given time threshold.

5. The method of claim 1 further comprising searching an electronic program guide for alternative sources of the video.

6. The method of claim 5 further comprising analyzing the prices of the alternative sources of the video.

7. The method of claim 5 further comprising acquiring the video from an alternative source.

8. The method of claim 5, wherein said search for alternative sources comprises at least one of searching the electronic program guide for a second content provider that provides the video and searching the Internet for the video.

9. One or more machine-readable media having stored therein a program product, which when executed a set of one or more processor units causes the set of one or more processor units to perform operations that comprise:
detecting an indication of a video which is accessible for a current fee from a content provider;
identifying a time when the video will be accessible for a future fee that is less than or equal to an indicated fee, wherein the time is within a given time threshold; and
scheduling acquisition of the video at the time.

10. The machine-readable media of claim 9, wherein said identifying comprises at least one of analyzing historical video fee information for videos from the content provider, examining published future fees for the video from the content provider, and examining video fee information from other content providers.

11. The machine-readable media of claim 10, where in the operations further comprise predicting the future fee based, at least in part, on the analyzing historical video fee information.

12. The machine-readable media of claim 9, where in the operations further comprise prompting a user for the indicated fee and the given time threshold.

13. The machine-readable media of claim 9, where in the operations further comprise searching an electronic program guide for alternative sources of the video.

14. The machine-readable media of claim 13, where in the operations future comprise analyzing the prices of the alternative sources of the video.

15. The machine-readable media of claim 13, wherein the operations future comprise acquiring the video from an alternative source.

16. The machine-readable media of claim 13, wherein said search for alternative sources comprises at least one of searching the electronic program guide for a second content provider that provides the video and searching the Internet for the video.

17. An apparatus comprising:
a set of one or more processing units;
a network interface; and
one or more machine-readable media having stored therein a program product, which when executed by the set of one or more processor units causes the set of one or more processor units to perform operations that comprise,
detecting an indication of a video which is accessible for a current fee from a content provider;
identifying a time when the video will be accessible for a future fee that is less than or equal to an indicated fee, wherein the time is within a given time threshold; and
scheduling acquisition of the video at the time.

18. The apparatus of claim 17 further comprising storage operable to store data about fee based videos, fees and time thresholds.

19. The apparatus of claim 17 further comprising an episode order adherence unit that comprises the one or more machine-readable media.

20. The apparatus of claim 17, wherein said identifying operation comprises at least one of analyzing historical video fee information for videos from the content provider, examining published future fees for the video from the content provider, and examining video fee information from other content providers.
